(19) United States
(12) Patent Application Publication
(10) Pub. No.: US 2007/0247597 A1
(43) Pub. Date: Oct. 25, 2007

(54) APPARATUS FOR ADJUSTING POSITION OF MIRROR

(75) Inventors: Edward Hy Lin, Wuri Shiang (TW); Aiven Huang, Puxin Shiang (TW)

Correspondence Address: SNELL & WILMER L.L.P. (Main), 400 EAST VAN BUREN, ONE ARIZONA CENTER, PHOENIX, AZ, 85004-2202, US

(73) Assignee: BENQ CORPORATION, Taoyuan (TW)

(21) Appl. No.: 11/737,604

(22) Filed: Apr. 19, 2007

(30) Foreign Application Priority Data
Apr. 20, 2006 (TW) 95114084

(51) Int. Cl. G03B 21/28

(52) U.S. Cl. 353/98; 353/77; 359/872

(57) ABSTRACT

An image forming apparatus includes a casing, a mirror, and an adjustment device for adjusting a position of the mirror. The adjustment device is disposed within the casing and includes a frame, a plate, a connection unit, a first adjustment unit, a connection element, and a first adjustment element. The frame includes a vertical surface and a horizontal surface with a hole therein. The plate is configured to hold the mirror. The connection unit and the adjustment unit are protrudedly disposed on the plate. The connection element connects the plate to the vertical surface of the frame. The first adjustment unit includes a first groove. The first adjustment element couples with the hole through the first groove. By adjusting the position of the first adjustment element in the first groove, a position of the plate relative to the frame is adjusted.

### CROSS REFERENCE TO RELATED APPLICATIONS

This application claims the right of priority based on Taiwan Patent Application No. 095114084 entitled “Apparatus For Adjusting Position Of Mirror And Image Forming Apparatus Having The Same,” filed on Apr. 20, 2006, which is incorporated herein by reference and assigned to the assignee herein.

### FIELD OF THE INVENTION

This invention relates to an electrical apparatus, and more particularly, to an image forming apparatus and an adjustment device for adjusting a position of a mirror.

### BACKGROUND OF THE INVENTION

Following the road of the industry and business activity and the interactive teaching, image forming apparatuses have gradually become indispensable electronic equipment in all kinds of activities. There are many kinds of image forming apparatuses on the market, including a LCD projector, a CRT projector, a slide projector, a film projector, and the like. These image forming apparatuses have a common feature of using optical systems to show images. In general, an optical system includes a plurality of optical elements (e.g., various mirrors), and a light beam carrying image signals passes through a light path defined by optical elements, and then projects to form an image on a target screen. Therefore, a better light path design typically generates a higher quality image.

An image forming apparatus generally is designed with a fixed light path. That is, the position of each mirror in the image forming apparatus is typically fixed. However, because of the manufacturing tolerance of each element, to obtain a better image, the positions of mirrors are generally adjusted to optimize the light path after the image forming apparatus is assembled. Conventional methods of adjusting a mirror have been disclosed in U.S. Pat. Nos. 6,880,934 and 6,000,802, which are incorporated by reference herein.

Therefore, there is a need to provide an image forming apparatus having a mirror adjustment function, so as to improve the image quality by adjusting the position of the mirror.

### SUMMARY OF THE INVENTION

One aspect of the present invention is to provide an adjustment device for adjusting a position of a mirror, which is capable of multi-directionally adjusting the position of the mirror so as to obtain a preferred light path configuration.

In one embodiment, the present invention provides an adjustment device for adjusting a position of a mirror, which includes a frame, a plate, a connection unit, a first adjustment unit, a connection element, and a first adjustment element. The frame has a vertical surface and a horizontal surface with a first hole therein. The plate is configured to hold the mirror. The connection unit and the adjustment unit are protrudedly disposed on the plate, and the first adjustment unit includes a first groove. The connection element connects the connection unit to the frame. The first adjustment element extends through the first groove and couples with the first hole. When the first adjustment element moves within the first groove, the plate has a corresponding movement relative to the frame.

In an exemplary embodiment, the connection unit can be a protrusion, and the protrusion and the first adjustment unit are on a same side opposite to the mirror. The connection element includes a screw and a spring, and the spring surrounds the screw so that the connection unit is adjustably connected to the frame by the screw. The first groove includes an inclined surface, and the position of the first adjustment element in the first groove is adjusted along the inclined surface.

Moreover, the adjustment device further includes a first spring surrounding the first adjustment unit, and the frame further includes a baffle. The spring is disposed between the plate and the baffle. The first adjustment element includes a screw. When the spring causes the screw to engage with the first hole at a first depth, the spring is at a first position of the first groove. When the screw couples with the first hole at a second depth, the first groove couples with the screw along the inclined surface so that the screw is at a second position of the first groove. The frame further includes a recess portion corresponding to the connection unit. The recess portion provides a space allowing a corresponding movement of the connection unit when the position of the plate relative to the frame is adjusted.

In another embodiment, the adjustment device further includes a second adjustment unit having a second groove. The second adjustment unit is protrudedly disposed on the plate and separated from the first adjustment unit in a predetermined distance. The frame further includes a second horizontal surface parallelledly distanced from the horizontal surface. The frame further has a second hole corresponding to the second groove. The adjustment device further includes a second adjustment element extending through the second groove and coupling with the second hole. The position of the plate relative to the frame is further adjusted by adjusting the position of the second adjustment unit in the second groove.

Additionally, the adjustment device further includes a plurality of clips for fixing the mirror on the plate, and each clip has a hole. The plate further includes a plurality of hooks. The hook engages with the hole of the clip so as to fix the mirror on the plate.

Another aspect of the present invention is to provide an image forming apparatus, which includes a casing, a mirror, and the above-mentioned adjustment device. By using the adjustment device to adjust the position of the mirror within the image forming apparatus, the light path can be optimized to obtain a better image quality and to enhance the performance of the image forming apparatus.

### BRIEF DESCRIPTION OF THE DRAWINGS

FIG. 1 is a three-dimensional view of an image forming apparatus in accordance with one embodiment of the present invention;

FIGS. 2A, 2B, and 2C are three-dimensional views of an adjustment device for adjusting a position of a mirror in accordance with one embodiment of the present invention;

FIG. 3 is an partially enlarged view of a frame in accordance with one embodiment of the present invention;

FIGS. 4A, 4B, and 4C are different directional views of a plate in accordance with one embodiment of the present invention; and

FIG. 5 is a schematic cross-sectional view illustrating operating an adjustment device for adjusting a position of a mirror in accordance with one embodiment of the present invention.

### DETAILED DESCRIPTION OF THE INVENTION

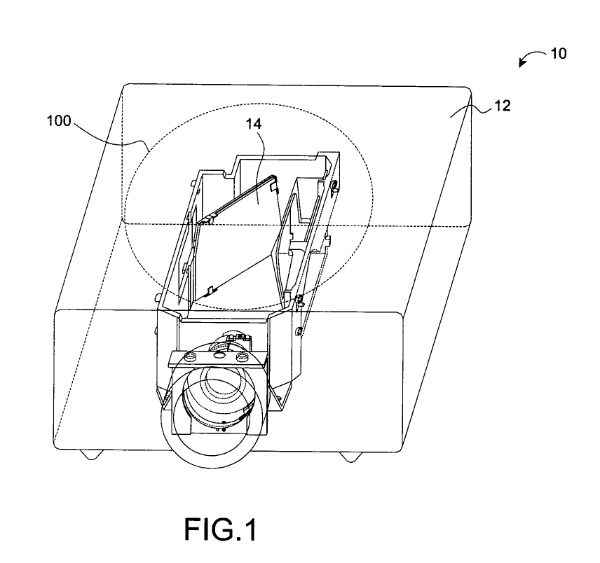

The present invention provides an image forming apparatus with an adjustment device, which is capable of multi-directionally adjusting a position of a mirror so as to optimize a light path and accordingly to enhance the quality of the image. The present invention may best be understood by reference to the following description in conjunction with the accompanying drawings from FIG. 1 to FIG. 5.

FIG. 1 illustrates a three-dimensional view of an image forming apparatus 10 in accordance with one embodiment of the present invention. In this embodiment, the image forming apparatus 10 is illustrated as a projection apparatus. However, the present invention is intended to cover various electronic devices in need of a mirror adjustment function. Taking a projection apparatus as an example, the image forming apparatus 10 includes a casing 12, a mirror 14, and an adjustment device 100. The adjustment device 100 is disposed within the casing 12 and configured to adjust the position of the mirror 14 so as to adjust a light path to achieve a better quality of image. It is noted that the image forming apparatus 100 may include other elements, such as lenses, a light engine, or other conventional elements, which are not deliberated herein, so as not to obscure the present invention.

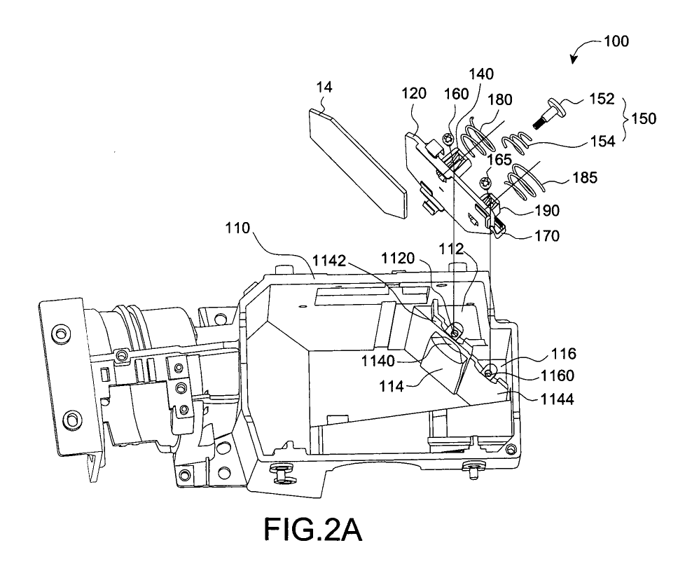

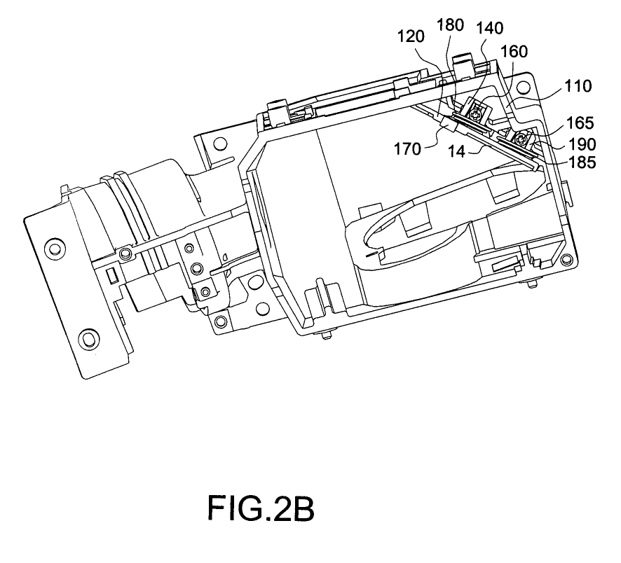

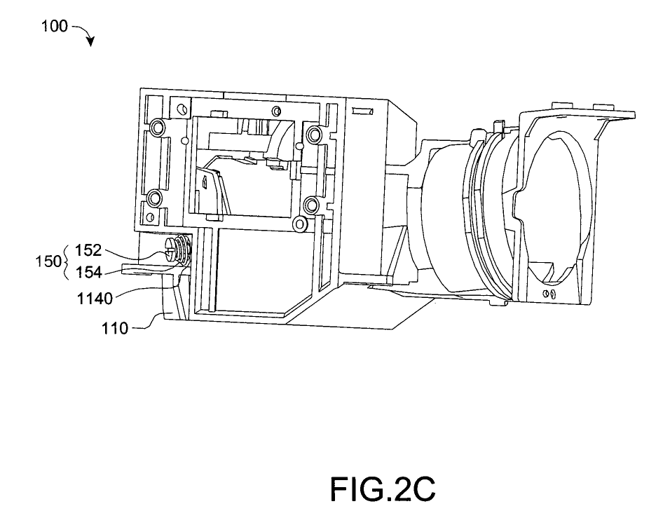

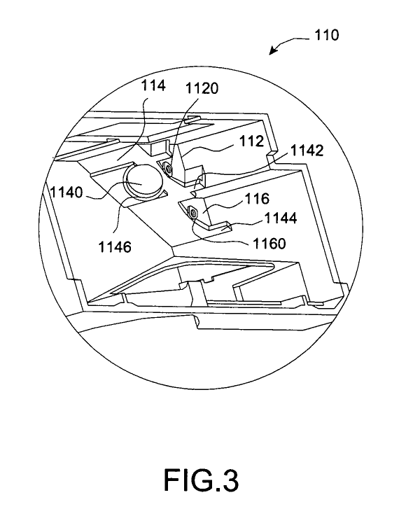

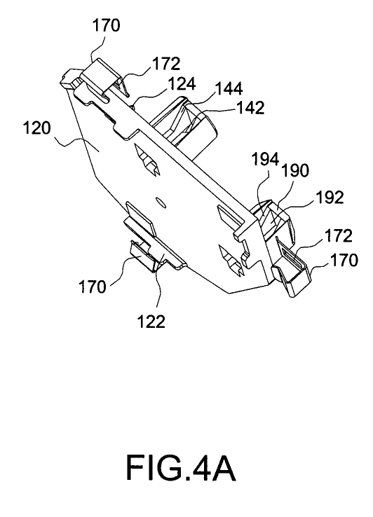

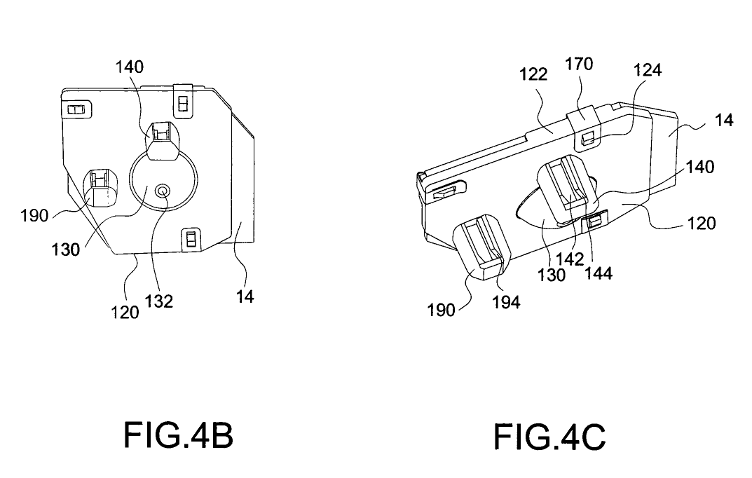

Referring to FIGS. 2A, 2B, and 2C, FIG. 2A shows an explosive view of the adjustment device 100, and FIGS. 2B and 2C show different directional views of the adjustment device 100 assembled with the mirror 14. As shown in FIG. 2A, the adjustment device 100 includes a frame 110, a plate 120, a connection unit 130 (shown in FIGS. 4B and 4C), a connection element 150, a first adjustment unit 140, a first adjustment element 160, a second adjustment unit 190, and a second adjustment element 165. For a more detailed illustration, please also refer to the partially enlarged view of the frame 110 in FIG. 3.

As shown in FIG. 2A and FIG. 3, the frame 110 includes a horizontal surface 112 and a vertical surface 114. The horizontal surface 112 has a first hole (a first coupling structure) 1120. The frame 110 shown in FIGS. 2A, 2B, and 2C can be a frame-like shape and incorporates with other optical elements or components to be disposed within the casing 12. It is noted that the frame 110 can have different variations according to different design need and is not limited to that shown in FIGS. 2A-2C. Referring to FIGS. 2A and 4A, the plate 120 is configured to hold the mirror 14. A support unit 122 is disposed on the edge of the plate 120. When the mirror 14 is disposed on the support unit 122 and leans on the plate 120, the mirror 14 is configured to reflect a light beam carrying image signals.

FIG. 4A illustrates a three-dimensional view of the plate 120, and FIGS. 4B and 4C are different directional views of the plate 120 assembled with the mirror 14. Referring to FIGS. 4A, 4B, and 4C, the connection unit 130 can be implemented as a protrusion disposed on the backside of the plate 120. The first adjustment unit 140 is disposed on the upper side of the plate 120 with respect to the connection unit 130, and the second adjustment unit 190 is disposed on the left side of the plate 120 with respect to the connection unit 130. Referring to FIGS. 2A, 2C, and FIG. 3, the connection element 150 passes through the opening 1140 so as to mount the connection unit 130 to the frame 110. As shown in FIGS. 4B and 4C, the connection unit 130 can have a hemisphere shape and is movably within the opening 1140 so that the connection of the connection unit 130 and the opening 1140 serves as a pivot. Therefore, the plate 120 can rotate in the vertical direction or the horizontal direction with respect to the pivot so as to adjust an elevation angle in the vertical direction or a rotation angle in the horizontal direction. The exemplary connection element 150 includes a screw 152 and a spring 154. The spring 154 surrounds the screw 152 so that the connection unit 130 is adjustably connected to the opening 1140 by the screw 152. In other words, one end of the screw 154, which has a larger diameter, contacts the wall of the frame 110 around the opening 1140. The other end of spring 154, which has a smaller diameter, touches against the screw nut of the screw 152, as shown in FIG. 2C. The connection unit 130 has a recess 132 corresponding to the screw 152. When the screw 152 incorporating with the spring 154 engages with the connection unit 130, the plate 120 is stably connected to the frame 110, and the adjustments of the vertical angle and the horizontal angle of the plate 120 are also feasible. It is noted that although the spring 154 with different diameters in two ends are illustrated in the exemplary embodiment, the shape of the spring 154 can vary with the size of the circumference of the frame 110 which defines the opening 1140 and the size of the screw nut of the screw 152.

As shown in FIGS. 4A, 4B, and 4C, the first adjustment unit 140 is in a columnar shape and has a first groove 142. When the connection element 150 connects the connection unit 130 to the frame 110, the first groove 142 corresponds to the hole 1120 (see FIG. 2A). As shown in FIG. 4C, the first groove 142 includes an inclined surface 144. The first adjustment element 160 extends through the first groove 142 and couples with the hole 1120. The position of the first adjustment element 160 within the first groove 142 can be adjusted along the inclined surface 144.

Moreover, when the plate 120 couples with the frame 110, the first spring 180 surrounds the columnar shape first adjustment unit 140, a first end of the first spring 180 contacts the plate 120, and a second end of the first spring 180 touches against a baffle 1142 of the frame 110 (as shown in FIG. 3).

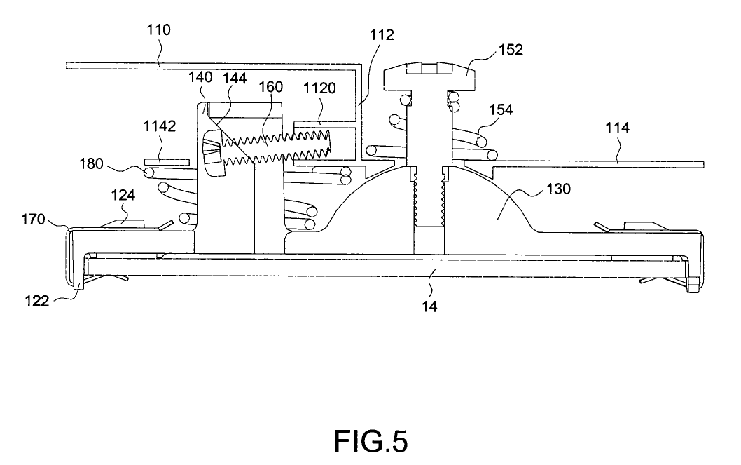

FIG. 5 shows a schematic cross-sectional view illustrating adjusting a position of the mirror 14 on the plate 120 by using the first adjustment element 160 incorporating with the spring 180 and the first adjustment unit 140. Referring to FIG. 5, when the first adjustment element 160, i.e. the screw, engages with the hole 1120 at a first depth, the screw 160 is at a first position of the first groove 142 (such as the highest point of the inclined surface 144). When the screw 160 engages with the hole 1120 at a second depth, the screw 160 is at a second position of the first groove 142 (such as the lowest point of the inclined surface 144).

That is, the inclined surface 144 of the first adjustment unit 140 couples with the screw nut of the screw 160. When the screw 160 downwardly couples with the hole 1120 to a deeper position, the screw nut of the screw 160 downwardly moves along the inclined surface 144 at the same time, so that the first adjustment unit 140 has a horizontal displacement relative to the hole 1120. The connection unit 130 serves as a connection pivot of the plate 120 and the frame 110, and the first adjustment unit 140 is at the upper side with respect to the protrusion 130, so that the horizontal displacement induces the effect of reducing the relative distance between the upper side of the plate 120 and the frame 110 so as to increase the elevation angle of the mirror 14.

When the screw 160 moves upwardly to engage with the hole 1120 to a shallower position, the spring 180 provides a restoring force to increase the relative distance between the upper side of the plate 120 and the frame 110. The restoring force causes the screw nut of the screw 160 to move upwardly along the inclined surface 144, so that the first adjustment unit 140 induces a horizontal displacement relative to the hole 1120. Therefore, the elevation angle of the mirror 14 is reduced. Furthermore, the elastic force of the spring 180 increases the stability when the screw 160 moves along the inclined surface 144, such as downwardly to couple with the hole 1120 to a deeper depth.

Similarly, the second adjustment unit 190 can operate in a similar manner, except that the second adjustment unit 190 is deposited on the left side of the plate 120 with respect to the connection unit 130. Therefore, the horizontal displacement induced by adjusting the position of the second adjustment element 165 within the second groove 192 can change the relative horizontal rotation angle of the plate 120 and the frame 110.

For instance, the frame 110 further includes a second horizontal surface 116 and a second hole (a second connection structure) 1160. The second adjustment unit 190 has a second groove 192. When the plate 120 connects with the frame 110, the second groove 192 corresponds to the second hole 1160. A second adjustment element 165 extends through the second groove 192 and couples with the second hole 160. When the second adjustment element 165 couples with the second hole 160 through the second groove 192, the position of the second adjustment element 165 in the second groove 192 can be adjusted along a second inclined surface 194.

As the plate 120 couples with the frame 110, a second spring 185 surrounds the columnar shape second adjustment unit 190. A first end of the second spring 185 contacts the plate 120, and a second end touches against a second baffle 1144 of the frame 110.

When the second adjustment unit 165, i.e. a screw, engages with the second hole 1160 at a first depth, the screw 165 is at a first position of the second groove 192 (such as the highest point of the second inclined surface 194). When the screw 165 engages with the second hole 1160 at a second depth, the screw is at a second position of the second groove 192 (such as the lowest point of the second inclined surface 194).

That is, the second inclined surface 194 of the second adjustment unit 190 contacts the screw nut of the screw 165. When the screw 165 downwardly couples with the second hole 1160 to a deeper position, the screw nut of the screw 160 downwardly moves along the second inclined surface 194 at the same time, so that the second adjustment unit 190 has a horizontal displacement relative to the second hole 1160. The connection unit 130 serves as the connection pivot of the plate 120 and the frame 110, and the second adjustment unit 190 is at left side with respect to the connection unit 130, so that the horizontal displacement induces the effect of reducing the relative distance between the left side of the plate 120 and the frame 110 so as to increase the horizontal rotation angle of the mirror 14.

When the screw 165 moves upwardly to engage with the second hole 1160 to a shallower position, the second spring 185 provides a restoring force to increase the relative distance between the left side of the plate 120 and the frame 110. The restoring force causes the screw nut of the screw 165 to move upwardly along the second inclined surface 194, so that the second adjustment unit 190 induces a horizontal displacement relative to the second hole 1160. Therefore, the horizontal rotation angle of the mirror 14 is reduced. Furthermore, the elastic force provided by the spring 185 increases the stability when the screw 165 moves along the second inclined surface 194, such as downwardly to couple with the second hole 1160 to a deeper depth.

It is noted that the arrangement of the second adjustment unit 190 and the first adjustment unit 140 are separated with a predetermined distance so as to multi-directionally adjust the relative position of the plate 120 and the frame 110.

That is, the central axes of the two columnar adjustment units 140 and 190 projecting on the plate 120 are not aligned in a line with respect to the connection unit 130. In such an arrangement, by using the connection of the connection unit 130 and the frame 110 as a pivot, the plate 120 is able to tilt in different directions according to different axes to achieve the multi-directional adjustment.

The vertical surface 114 of the frame 110 may include a recess 1146 corresponding to the convex surface of the connection 130. When the relative position of the plate 120 and the frame 110 is adjusted, the recess 1146 provides a space allowing the connection unit 130 to move without interfering with the vertical surface 114. Furthermore, the connection unit 130, the first adjustment unit 140, and the second adjustment unit 190 can be integrally formed as one piece or individually formed as separate components.

Moreover, as shown in FIGS. 4A-4C and FIG. 5, the adjustment device 100 further includes a plurality of clips 170 for fixing the mirror 14 on the plate 120. The clip 170 can be a U shape clip and have a hole 172 in one side. The plate 120 further includes a hook 124 corresponding to the hole 172 of the clip 170. When the mirror 14 is disposed on the support unit 122 of the plate 120, the hook 124 engages with the hole 172 of the clip 170 and the other end of the clip 170 contacts the mirror 14 so as to fix the mirror 14 on the plate 120. It is noted that the mirror 14 can be disposed on the plate 120 in different manners and not be limited to the embodiment. For example, the mirror 14 can be glued on the plate 120.

The image forming apparatus 10 with the adjustment device 100 of the present invention allows an operator to multi-directionally adjust the vertical elevation angle and the horizontal rotation angle of the mirror 14 conveniently so as to obtain a preferred light path improving the image quality.

Although specific embodiments have been illustrated and described, it will be obvious to those skilled in the art that various modifications may be made without departing from what is intended to be limited solely by the appended claims.

1. An adjustment device for adjusting a position of a mirror, comprising:
a frame having a first hole;
a plate for holding the mirror;
a connection unit disposed on said plate;
a first adjustment unit disposed on said plate, said first adjustment unit having a first groove extending along a second direction;
a connection element connecting said connection unit to said frame; and
a first adjustment element extending through said first groove and coupling with said first hole,
wherein when said first adjustment element moves within said first groove, said plate has a corresponding movement relative to said frame.

2. The adjustment device of claim 1, wherein said connection element includes a screw and a spring, and said spring surrounds said screw so that said connection unit is adjustably connected to said frame by said screw.

3. The adjustment device of claim 1, wherein said first groove includes an inclined surface, and said position of said first adjustment element in said first groove is adjusted along said inclined surface.

4. The adjustment device of claim 3, further comprising:
a spring surrounding said first adjustment element, wherein said frame further includes a baffle, and said spring is disposed between said plate and said baffle.

5. The adjustment device of claim 4, wherein said first adjustment element includes a screw, and when said spring causes said screw to engage with said first hole at a first depth, said spring is at a first position of said first groove.

6. The adjustment device of claim 5, wherein when said screw couples with said first hole at a second depth, said first groove couples with said screw along said inclined surface so that said screw is at a second position of said first groove.

7. The adjustment device of claim 1, wherein said frame further includes a recess portion corresponding to said connection unit, and said recess portion provides a space allowing a corresponding movement of said connection unit when said position of said plate relative to said frame is adjusted.

8. The adjustment device of claim 1, further comprising:
a second adjustment unit having a second groove, wherein said frame further includes a second hole corresponding to said second groove.

9. The adjustment device of claim 8, further comprising:
a second adjustment element extending through said second groove and coupling with said second hole, wherein when said second adjustment element moves within said second groove along said second direction, said plate has a corresponding movement relative to said frame.

10. The adjustment device of claim 9, wherein said second groove includes a inclined surface, said second adjustment element adjusts said position of said second adjustment element in said second groove along said inclined surface.

11. The adjustment device of claim 10, further comprising:
a second spring surrounding said second adjustment element, wherein said frame further includes a second baffle, and said second spring is disposed between said plate and said second baffle; and wherein said second adjustment element includes a screw, so that when said spring causes said screw to engage with said second hole at a first depth, said spring is at a first position of said second groove.

12. The adjustment device of claim 11, wherein when said screw engages with said second hole in a second depth, said second groove couples with said screw along said inclined surface so that said spring is at a second position of said second groove.

13. The adjustment device of claim 1, further comprising a plurality of clips, wherein each of said clips has a hole, said plate further includes a plurality of hooks, and said hook engages with said hole of said clip so as to fix said mirror on said plate.

14. An adjustment device for adjusting a position of a mirror, comprising:
a frame including a first coupling structure;
a plate for holding the mirror, said plate having a connection unit;
a first adjustment unit having a first inclined surface, disposed on said plate and separated from said connection unit with a predetermined distance;
an elastic element disposed between said frame and said plate; and
a first adjustment element having a first portion and a second portion, said first portion coupling with said first inclined surface, and said second portion coupling with said first coupling structure,
wherein by adjusting the engagement depth between said second portion and said first coupling structure along a first direction, said elastic element enables said first adjustment element having a corresponding movement along said first inclined surface, so that said plate moves along a second direction in response to said corresponding movement, and said first direction is different from said second direction.

15. The adjustment device of claim 14, wherein by increasing said engagement depth between said first adjustment element and said coupling structure along said first direction, said plate moves along said second direction to approach said frame; and by decreasing said engagement depth between said first adjustment element and said coupling structure along said first direction, said plate moves along said second direction away from said frame.

16. The adjustment device of claim 14, wherein said frame further includes a baffle, and said elastic element surrounds said first adjustment unit and is disposed between said plate and said baffle.

17. The adjustment device of claim 14, wherein said first coupling structure includes a first hole, said first adjustment unit includes a first groove, said first inclined surface is disposed on a sidewall defining said first groove, and said first adjustment element extends through said first groove and couples with said first hole along said first inclined surface.

18. The adjustment device of claim 14, wherein said connection unit movably connects with said frame by a connection element including a screw and a spring, and said spring surrounds said screw.

19. The adjustment device of claim 14, wherein said frame includes a recess portion corresponding to said connection unit, said recess portion provides a space allowing a corresponding movement of said connection unit when said plate moves along said second direction.

20. The adjustment device of claim 14, further comprising:
a second coupling structure formed on said frame;
a second adjustment unit having a second inclined surface, disposed on said plate and separated from said first adjustment unit with a distance;
a second elastic element disposed between said frame and said plate; and
a second adjustment element having a first portion and a second portion, said first portion coupling with said second inclined surface, and said second portion coupling with said second coupling structure,
wherein by adjusting the engagement depth between said second portion and said second coupling structure along said first direction, said elastic element enables said second adjustment element having a corresponding movement along said second inclined surface so that said plate moves along a third direction in response to said corresponding movement, and wherein said first direction is different from said third direction.

21. The adjustment device of claim 20, wherein said second adjustment unit includes a second groove, said second inclined surface is disposed on a sidewall defining said second groove, and said second adjustment element extends through said second groove and couples with said second coupling structure along said second inclined surface.

22. The adjustment device of claim 14, further comprising a plurality of clips, wherein each of said clip has a hole, said plate further includes a plurality of hooks, and at least one of said plurality of hooks engages with said hole of said clip to fix said mirror on said plate.
